(19) United States
(12) Patent Application Publication
(10) Pub. No.: US 2006/0240876 A1
(43) Pub. Date: Oct. 26, 2006

(54) Pen with an indicating function for receiving a phone call

(76) Inventor: Mo-Hsin Chang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/109,625

(22) Filed: Apr. 20, 2005

(51) Int. Cl. H04B 1/38

(52) U.S. Cl. 455/567

(57) ABSTRACT

A pen with an indicating function for receiving a call to a cell phone includes a sound and light electronic circuit arranged in an interior of the pen. The sound and light electronic circuit is composed of a battery, a light emitter, a speaker and a switch (maybe consisting of a manual switch and a call indicating switch of a cell phone connected in parallel). The light emitter is lit up by pressing the manual switch, and the light shines out through a transparent upper portion of the pen to make the pen look starkly to be used as indicating and lightening. The call indicating switch is electrified in case a call comes to the cell phone, with the light emitter lit up and the speaker sounded out together the cell phone electrified, improving a flaw that a call to the cell phone is hard to detect owing to its location placed.

### BACKGROUND OF THE INVENTION

1. Field of the Invention

This invention relates to a pen with an indicating function for receiving a phone call, particularly to one to indicate a phone-call with a sound and a light for a cell-phone in case there is a call to the cell phone to remind a user, as the cell phone is often placed at such a location that the phone-call signal is not so easy to be heard or seen.

2. Description of the Prior Art

A conventional pen is often carried in a pocket for writing mainly and for adornment subordinately, without any other purpose. So this invention is a first attempt to offer a pen with an indicting function for receiving a phone call of a cell phone.

### SUMMARY OF THE INVENTION

The feature of the invention is a sound and light electronic circuit provided in the shell of a pen, which consists of a battery, a light emitter, a speaker and a switch (a manual switch connected in parallel to the call indicating switch of a cell phone). If the manual switch is electrified, the light emitter is lit up to shine through the transparent upper shell of the pen to let the pen look starkly and also functioning as lightening and indicating. When there is a phone call to the cell phone, the light emitter is lit up and the speaker sounds out at the same time so as to remind the user so. Then the pen has an auxiliary function for showing that there comes a phone call to the cell phone.

### BRIEF DESCRIPTION OF DRAWINGS

This invention will be better understood by referring to the accompanying drawings, wherein:

FIG. 1 is a perspective view of a pen with an indicating function for receiving a phone call of a cell phone;

FIG. 2 is an exploded perspective view of the pen in the present invention;

FIG. 3 is a diagram of a sound and light electronic circuit in the present invention; and,

FIG. 4 is a side view of the pen in the present invention, showing it being used.

### DETAILED DESCRIPTION OF THE PREFERRED EMBODIMENT

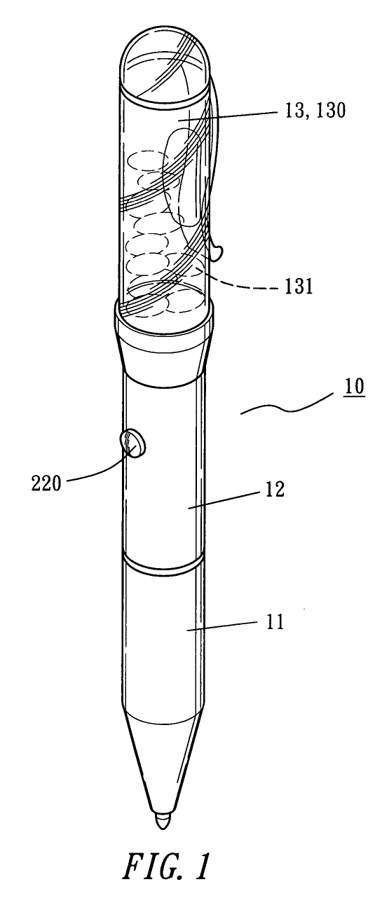

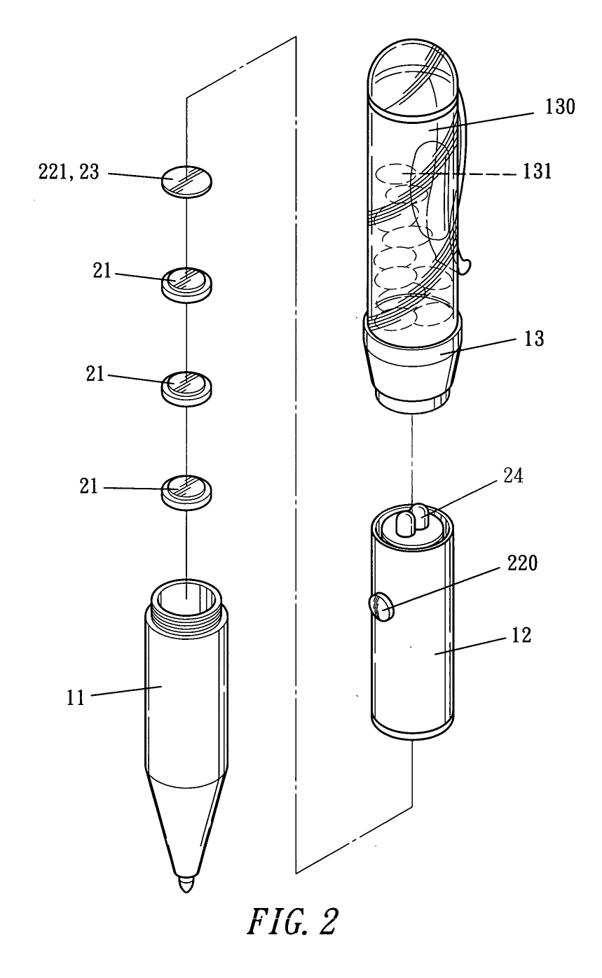

A pen 10 with an indicating function for receiving a phone call of a cell phone in the present invention, as shown in FIGS. 1, 2 and 3, includes a lower shell 11, an intermediate shell 12 combined with the lower shell 11, a transparent upper shell 13 combined with the intermediate shell 12, and a sound and light electronic circuit 20 deposited in the lower and the intermediate shell 12 and 11 as main components.

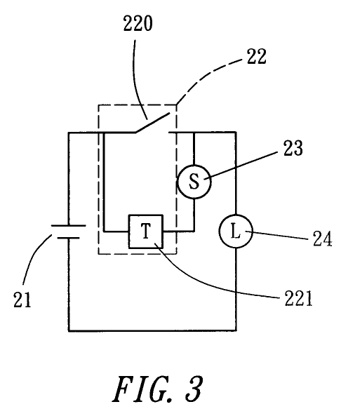

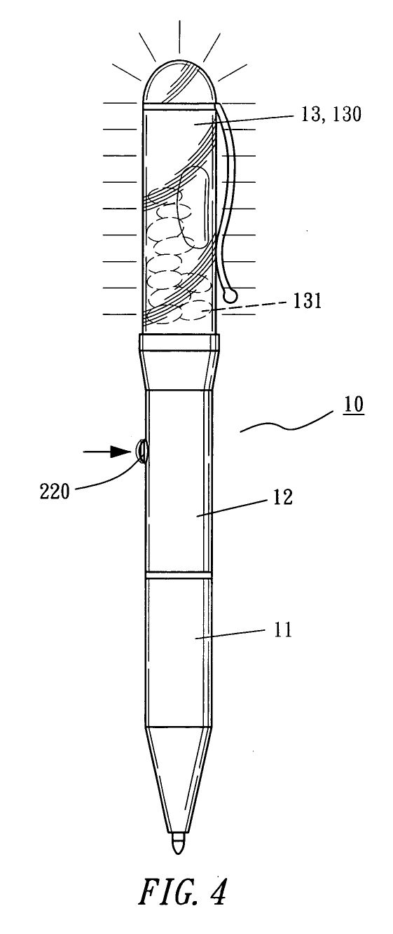

The sound and light electronic circuit 20 is composed of a battery 21, a switch 22 consisting of a manual switch 220 and a call indicating switch 221 of a cell phone connected in parallel with the manual switch 220, as shown in FIG. 3), a speaker 23 (fixed in the call indicating switch 221), and a light emitter 24. The speaker 23 is connected in series with the call indicating switch 221, and then connected in parallel with the manual switch 220. Then in case the manual switch 220 is pressed, the light emitter 24 is lit up only, throwing light out through the transparent upper shell 13, as shown in FIG. 4. But when a phone call comes to the cell phone, the call indicting switch 221 is electrified, turning on the speaker 23 and lighting up the light emitter 24 at the same time, so the upper shell 13 may reflect light as well, reminding the user of a phone call coming to the cell phone, functioning as an auxiliary use of the pen.

Next, in order to make the upper shell 13 more intriguing for shining, a liquid 130 and a float 131 are filled in the interior of the upper shell 13, let the light of the light emitter 24 reflected by the liquid 130 to shine more brilliantly.

As can be seen from the foresaid description, the invention has the following advantages.

1. The light emitter 24 gives out light and the upper shell reflects the light more brilliant if the manual switch 220 is pressed.

2. When a call comes to the cell phone, the call indicating switch 221 in the pen 10 is electrified to start the light emitter 24 and the speaker 23, noticing the user of the phone call, serving as an auxiliary indicating means.

While the preferred embodiment of the invention has been described above, it will be recognized and understood that various modifications may be made therein and the appended claims are intended to cover all such modifications that may fall within the spirit and scope of the invention.

What is claimed is:

1. A pen with an indicating function for receiving a call to a cell phone, said pen comprising a sound and light electronic circuit provided in its interior, said sound and light circuit composed of a battery, a call indicating switch to be electrified by a call to a cell phone, a speaker and a light emitter, said pen having at least a transparent portion for the light of said light emitter to shine through out; said call indicating switch of said sound and light electronic circuit electrified in case a call comes to the cell phone to let said light emitter lit up and said speaker sounded out so that the user may be reminded of the call coming, said pen having an auxiliary function of calling attention of the user of the cell phone at the moment when a phone call comes.

2. The pen with an indicating function for receiving a call to a cell phone as claimed in claim 1, wherein said sound and light electronic circuit is provided with a manual switch connected in series with said call indicating switch after said call indicating switch is connected in parallel with said speaker and said light emitter.

3. The pen with an indicating function for receiving a call to a cell phone as claimed in claim 1, wherein said transparent portion of said pen is an upper portion.
